(19) United States
(12) Patent Application Publication
(10) Pub. No.: US 2011/0300471 A1
(43) Pub. Date: Dec. 8, 2011

(54) NANOPARTICLE COATED ELECTRODE AND METHOD OF MANUFACTURE

(75) Inventors: Kimberly McGrath, Newport Beach, CA (US); Robert Dopp, Marietta, GA (US); R. Douglas Carpenter, Tustin, CA (US)

(73) Assignee: QUANTUMSPHERE, INC., Santa Ana, CA (US)

(21) Appl. No.: 13/212,032

(22) Filed: Aug. 17, 2011

Related U.S. Application Data
(63) Continuation of application No. 11/868,152, filed on Oct. 5, 2007, now abandoned.

(51) Int. Cl. C25B 11/06; C25B 11/08; B05D 5/12; H01M 4/90; H01M 4/88; C25B 11/04; H01M 4/86

(52) U.S. Cl. 429/532; 204/290.03; 204/290.04; 427/77

(57) ABSTRACT

An electrode comprising a primary and secondary metal nanoparticle coating on a metallic substrate is prepared by dispersing nanoparticles in a solvent and layering them onto the substrate, followed by heating. The enhanced surface area of the electrode due to the catalytic nanoparticles is dramatically enhanced, allowing for increased reaction efficiency. The electrode can be used in one of many different applications; for example, as an electrode in an electrolysis device to generate hydrogen and oxygen, or a fuel cell.

### CROSS-REFERENCE TO RELATED APPLICATION

This application is a continuation of U.S. patent application Ser. No. 11/868,152, filed Oct. 5, 2007, the entire contents of which are incorporated herein by reference.

### BACKGROUND OF THE INVENTION

1. Technical Field

The inventions disclosed herein relate generally to catalysts for electrochemical reactions, and specifically to, for example, electrodes for use in electrolysis and fuel cell devices.

2. Related Art

Hydrogen is a renewable fuel that produces zero emissions when used in a fuel cell, and significantly reduces emissions (while improving fuel economy) when injected into the fuel stream of an internal combustion engine such as a diesel engine. It is well known that the combustion of hydrogen and oxygen gas in a diesel or gasoline fuel stream improves fuel efficiency and horsepower because hydrogen and oxygen burn faster and hotter than diesel or fossil fuels, dramatically boosting combustion efficiency and more thoroughly consuming the fuel.

The reduction of diesel emissions is a critical aspect in the improvement of air quality throughout the world. In the state of California alone, over 70% of particulate matter emissions (PMs) are from diesel engines. Both the EPA and air quality management districts across the country are implementing new mandates to reduce diesel truck emissions (PMs, NOₓ, SOₓ). Several strategies exist for making diesel engines compliant with new standards; namely the use of PM filters, engine retrofit, or engine replacement. Unfortunately, particulate matter filters are costly and require intermittent cleaning, which dumps the PMs into landfills instead of the air. Replacement of older diesel engines with new engines would require a massive expenditure for fleet owners.

Alternatively, hydrogen can be used in a hydrogen fuel cell, which are presently used to convert hydrogen rich fuel into electricity without combusting the fuel. For example, methanol, propane, and similar fuels that are rich in hydrogen and/or pure hydrogen gas fuel cell systems have been developed which generate electricity from the migration of the hydrogen in those fuels across a membrane. Because these fuels are not burned, pollution from such fuel cells is quite low or non-existent. These fuel cells are generally more than twice as efficient as gasoline engines because they run cooler without the need for insulation and structural reinforcement.

Devices that are configured to electrochemically convert reactants into products when energy is applied are generally known as electrolyzers. For an electrolyzer to operate with high efficiency, the amount of product produced during reaction should be maximized relative to the amount of energy input. In many conventional devices, significant efficiency loss stems from low catalyst utilization in the electrodes, cell resistance, inefficient movement of electrolyte, and inefficient collection of reaction products from the electrolyte. In many cases, low efficiency is compensated for by operating the cell at a low rate (current). While this strategy increases efficiency, it also lowers the amount of products that can be produced at a given time.

The principal method to produce hydrogen is by steam reformation. Over 95% of the hydrogen currently being produced is made by steam reformation, where natural gas is reacted with water on metallic catalyst at high temperature and pressure. While this process is relatively low cost, it is not environmentally friendly. Four pounds of the greenhouse gasses carbon monoxide (CO) and carbon dioxide (CO₂) are produced for every one pound of hydrogen. Without further purification to remove polluting CO and CO₂, hydrogen remains an unacceptable fuel alternative when generated by steam reformation, as is a poison for many fuel cell catalysts. The process of effective purification necessary to make it more ecologically acceptable, however, makes it cost prohibitive.

Alternatively, hydrogen may be produced from water electrolysis. This reaction is the direct splitting of water molecules to produce hydrogen and oxygen, which produces no greenhouse gasses. This process typically involves submersing electrodes composed of catalyst particles into water and applying electrical energy to them. The application of energy causes the electrodes to split water molecules into hydrogen and oxygen. Hydrogen is produced at the cathode electrode, which accepts electrons, and oxygen is produced at the anode electrode, which liberates electrons. The amount of hydrogen and oxygen produced by an electrode depends in part upon the current supplied to the electrodes. Efficiency depends on the voltage between the two electrodes, and is inversely proportional to the voltage; i.e., efficiency increases as the voltage decreases. A more catalytic system will have a lower voltage for any one current, and therefore be more efficient in producing hydrogen and oxygen. If the catalyst has high efficiency, there will be minimal energy input to achieve a maximum hydrogen output. Currently, electrolysis is too expensive to compete with steam reformation due to low efficiency and expensive catalyst electrodes. It is, therefore, desirable to have a more efficient electrode for generating energy in a cost effective manner.

### SUMMARY OF THE INVENTION

In one embodiment of the invention, a high-surface area electrode is provided that comprises a substantially solid metallic substrate (or plate) having a primary and secondary layer (or first and second layer) of metal nanoparticles. The metallic substrate can be a plate, foam, porous wafer, or woven metal cloth. The metallic substrate can be comprised of a metal selected from Groups 3-16, lanthanides, combinations thereof, and alloys thereof, or stainless steel, cold-rolled steel, or nickel. The surface of the metallic substrate may be contoured such that the geometric surface area is increased, including but not limited to, etched patterns, grooves, and/or sandblasting.

The primary layer may comprise nanoparticles of copper, silver, or gold. It is desirable that the primary metal nanoparticle coating be evenly distributed on the metallic substrate and have good surface coverage. This may be accomplished by way of an inventive method for applying nanoparticle coatings to the electrode substrate. In one application, the inventive method comprises preparing a dispersion of nanoparticles in a solvent. Desirably, but not necessarily, the solvent is volatile, and is easily evaporated at temperatures below 300° C. The dispersion of the primary metal nanoparticle coating may be accomplished by a variety of methods, including but not limited to painting, spraying, or screen printing. Following application, the primary coating can be followed by heat treatment between 500-1000° C. to sinter metal nanoparticles together to provide structural integrity.

One embodiment of the present invention also comprises a secondary nanoparticle coating applied on top of the first nanoparticle coating. This may be accomplished, for example, in the same manner as the first coating. The second coating may comprise nickel, iron, manganese, cobalt, tin, chromium, lanthanum, and palladium, and alloys thereof, and their respective oxides. Certain composites, such as stainless steel metal nanoparticles, are also contemplated.

When metal nanoparticles are layered onto an electrically conductive substrate surface, the surface area of that electrode is increased significantly relative to that of the substrate alone. The primary nanoparticle layer provides enhanced surface area to the substrate and allows good connection between the substrate and secondary layer of nanoparticles. This secondary layer may be the most active layer of the electrode, and can provide for an increase in the rate of electrochemical reactions, thus, improving efficiency. These electrodes may provide both a cost and performance improvement compared to traditional electrodes in electrochemical systems, such as an electrolyzer or fuel cell.

The nanoparticle-coated electrodes described herein can be applied to a variety of electrochemical devices, including a hydrogen generating electrode in a water electrolyzer system or a fuel cell.

### BRIEF DESCRIPTION OF THE DRAWINGS

FIG. 1 is a schematic of the primary and secondary layers applied to the surface of a plate to form one embodiment of the inventive electrode.

FIG. 2 is a voltammogram comparing the electrical performance of the inventive electrodes described herein with other electrodes.

### DETAILED DESCRIPTION

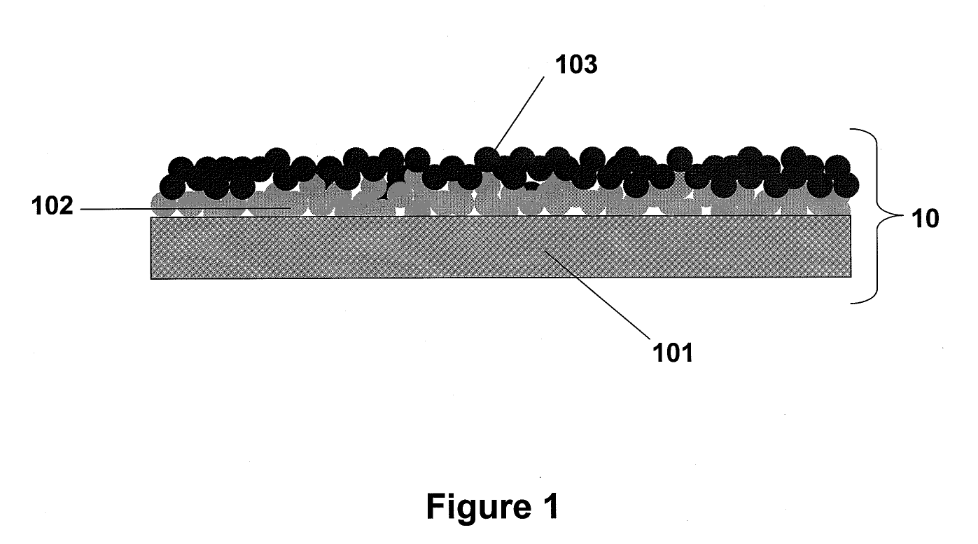

The inventive electrodes described herein comprise a substrate coated with one or more layers of metal nanoparticles. An electrode coated with a primary and secondary nanoparticle coating is shown in FIG. 1. In one embodiment of the invention, a high-surface area electrode 10 is provided that comprises a substantially solid metallic substrate (or plate) 101. The metallic substrate 101 can be formed, for example, as a plate, a foam, a porous wafer, or woven metal cloth. The metallic substrate can be comprised of a metal selected from Groups 3-16, lanthanides, combinations thereof, and alloys thereof, or stainless steel, cold-rolled steel, or nickel. The surface of the metallic substrate may be contoured such that the geometric surface area is increased, including but not limited to, corrugation, etched patterns, grooves, and/or sandblasting.

Desirably, the electrode 10 further comprises a primary coating 102 that itself comprises low-melting-point metal nanoparticles with high conductivity applied to the surface of the metal substrate 102. The primary layer is comprised of a metal that promotes adhesion of a desirable secondary coating to the metallic plate, such that the coatings remain robust and intact when electricity is applied to the electrode. The primary coating 101 may comprise, for example, silver, copper, and/or gold. Other materials may be used that serve to promote adhesion of a desired second layer. The primary coating should form an even surface on the substrate and provide full coverage on the substrate 101.

Once the primary coating 102 is adhered to substrate 101, a secondary nanoparticle coating 103 may be applied. The secondary nanoparticle coating desirably comprises materials that exhibit electro-catalytic activity in electrolysis and fuel cell devices. This secondary coating 103 may comprise nickel, iron, manganese, cobalt, tin, chromium, lanthanum, and palladium, and alloys thereof, and their respective oxides. Certain composites, such as stainless steel metal nanoparticles, are also contemplated. The secondary coating 103 should form an even surface atop the primary coating 102 and provide substantial coverage over the primary coating. Secondary coating 103 may be adhered to primary coating 102 by a higher temperature heat treatment. In any case, the electrode substrate 101, primary layer 102, and secondary layer 103 should not decompose in alkaline environment.

The metal nanoparticles referenced herein may be selected from the group consisting of nickel, iron, manganese, cobalt, and tin, chromium, lanthanum, silver, and palladium, or combinations, alloys, and oxides thereof. Additionally, the metal nanoparticles may comprise a metal core and an oxide shell having a thickness in the range from 5 to 100% of the total particle composition, wherein the metal core may be an alloy. Although larger sizes are contemplated, the metal nanoparticles desirably have a diameter of less than 100 nm. The smaller the nanoparticles size, the more likely they are to efficiently coat the surface of the metal substrate particles. Metal nanoparticles may be produced by a variety of methods. One such method is detailed in U.S. Pat. No. 7,282,167, Ser. No. 10/840,409, which is incorporated herein in its entirely by reference.

A significant advantage to using nanoparticle-coated electrodes is that the electrodes can be made in a variety of shapes and sizes to accommodate various electrolysis cells, fuel cells, and cell stack designs. Another advantage is that the electrode has a considerably higher surface area to permit electrochemical reaction relative to other electrodes. Other advantages may include, depending upon the configuration, circumstances, and environment, long term operational stability, lower cost, commercial scalability, a higher rate of hydrogen production, and higher electrical efficiency. Typical electrolyzer electrodes have a far lower surface area and, thus, cannot operate at rates significant enough to produce large quantities of hydrogen. While efforts have been made to increase the surface area of the electrodes, use of a stable nanoparticle coating has not been previously successful.

We experienced significant difficulty in providing good adhesion between a metallic substrate such as stainless steel or nickel, and catalytically active metal nanoparticles, especially if the particles have a high melting point or do not have affinity for the substrate. In addition, metal nanoparticles with an oxide shell have higher thermal insulation than a bare metal nanoparticle, thus making melting or sintering more difficult. However, the temperature must still be low enough as to not flow the metal, which causes a significant loss of surface area. To achieve our goal of a low cost, high activity electrode, a new method was invented to overcome this challenge.

The method used herein describes a multi-layer approach to promote adhesion of nanoparticles to a metallic surface to form a high surface area electrode. In a first aspect, nanoparticles are dispersed in a volatile solvent, such as an alcohol or ethylene glycol, directly applied to the metallic substrate surface. By applying the nanoparticles as a fluid suspension, an even coating across the metallic substrate can be established. After a layer is applied, the solvent can be removed by heating. Selecting a solvent with an evaporation point below 300° C. facilitates the drying process. Upon heating, the solvent evaporates and the primary metal nanoparticles begin to lightly sinter. Despite this mild sintering, a plurality of the particles remain at the nanoscale and retain their high surface area. The metallic substrate should be sufficiently coated with the primary nanoparticle coating such that the surface of the metallic substrate is not exposed. In this respect, the primary nanoparticle dispersion may be applied and heated multiple times to ensure complete coverage. The substrate should be cooled before another layer of primary coating is applied so that the particles do not begin to sinter before they adhere to the metallic substrate.

In another aspect of the invention, the metallic substrate with primary nanoparticle coating is placed into a heating chamber, such as a furnace, to promote physical contact between the substrate and the nanoparticles. For example, a metallic substrate such as stainless steel has an annealing temperature similar to 900° C. At this stage, atoms may diffuse through the material; this movement promotes interaction of the primary nanoparticle coating and stainless steel. In the same manner, the second layer 103 may be applied to the primary layer 102.

In another aspect of the invention, the metallic substrate with secondary nanoparticle coating is placed into a heating chamber, such as a furnace to promote physical contact between the primary coating and secondary coating. For example, the primary coating of silver begins to sinter at a temperature of about 300° C., and the secondary coating at a temperature similar to 500° C. As such, the heating chamber would be taken to at least 300° C. to initiate physical interaction of the primary and secondary coating.

It is also contemplated that the primary and secondary nanoparticle mixtures may be coated simultaneously. For example, a dispersion of nano silver may be mixed with a dispersion of nano nickel, and then coated onto the metallic substrate. Provided there is enough of the primary mixture within the mixed composition, there can be sufficient adhesion of nanoparticles to the substrate.

A heating process is commonly used in known sintering techniques. However, heating of the metal nanoparticles on the metallic substrate should be limited so as to not allow excessive grain growth. For example, if the reactive metal particles and metal substrate particles are heated excessively, thereby causing excessive grain growth, the particles combine to form larger particles. This growth reduces the surface-area-to-volume ratio of the particles, and thereby reduces the number of reaction sites available for catalytic functions. One of ordinary skill in the art should recognize that any sintering process is likely to produce some grain growth and, thus, it is anticipated that the resulting electrodes will include grains that have grown larger than the original nickel particles, including grain sizes that are larger than “nano-scale”. However, optimization of the heating process during sintering preserves the nano-scale size of the original particles and yet forms a coating that is structurally stable.

The foregoing description is that of preferred embodiments having certain features, aspects, and advantages in accordance with the present inventions. Various changes and modifications also may be made to the above-described embodiments without departing from the spirit and scope of the inventions.

### Example 1

### Preparation of a Nanoparticle Electrode

About 2 grams of nano-silver powder was blended into 5 grams of ethylene glycol. The resulting primary nanoparticle dispersion was stirred for five minutes. Nickel was cut to the desired electrode shape and coated with the dispersion. The nickel with silver layer was heated to evaporate off the solvent and allowed to cool. The process was repeated an additional 3-4 times. After the final primary layer was applied, the coated nickel plate was placed in a furnace at 900° C. for one hour and then allowed to cool. A second metal nanoparticle dispersion was prepared by combining 0.5 grams of nano nickel particles with 0.5 grams of nano iron particles into 3 grams of ethylene glycol. The resulting dispersion was stirred for five minutes. The metallic plate coated with the primary nanoparticle coating was layered with this dispersion. The secondary nanoparticle layer was heated to evaporate off the solvent and allowed to cool. The process was repeated an additional 3-4 times. After the final primary layer was applied, the electrode was placed in a furnace at 750° C. for one hour and then allowed to cool.

### Example 2

### Electrode Performance

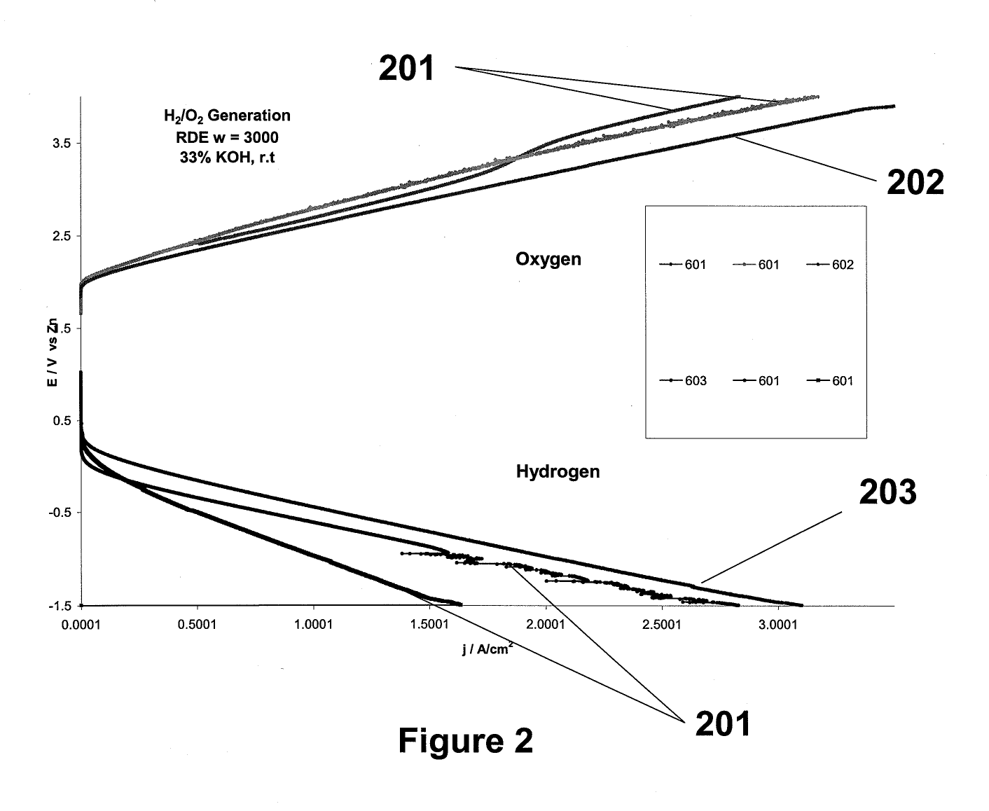

Cathodes were tested using a half-cell apparatus to independently test the electrode activity for hydrogen and oxygen generation. Electrolyte was a 33% KOH solution against a zinc-wire reference electrode. FIG. 2 shows a set of galvanostatic tests at 1 A/cm² for oxygen generation and a set for hydrogen generation. The most inefficient electrodes, shown as lines 201 are the lowest and highest lines on the hydrogen and oxygen curves, respectively. The most efficient electrodes were the nanoparticle coated electrodes. Lines 202 and 203 illustrate this enhanced performance.

The foregoing description is that of preferred embodiments having certain features, aspects, and advantages in accordance with the present inventions. Various changes and modifications also may be made to the above-described embodiments without departing from the spirit and scope of the inventions.

What is claimed is:

1. An electrode suitable for use in at least one electrochemical or catalytic application, the electrode comprising a substantially solid metallic substrate, a first coating of metal nanoparticles layered on the substrate, and a second coating of metal nanoparticles layered on the first coating, whereby said first coating promotes adhesion of the second coating by creating a direct metal-to-metal bond between the nanoparticles of the first coating and nanoparticles of the second coating.

2. The electrode of claim 1 wherein the metallic substrate is comprised of a metal selected groups 3-16, lanthanides, combinations thereof, and alloys thereof.

3. The electrode of claim 2, wherein the metallic substrate is comprised of stainless steel or nickel.

4. The electrode of claim 3, wherein the metallic substrate has a contoured surface to promote greater adherence of the first coating to said substrate.

5. The electrode of claim 1, wherein the metallic substrate comprises either a metal plate, porous wafer, foam, or woven wire cloth.

6. The electrode of claim 1, wherein the first coating comprises nanoparticles of copper, silver, or gold.

7. The electrode of claim 1, wherein the second coating is comprised of metals selected from groups 3-16, lanthanides, combinations thereof, oxides thereof and alloys thereof.

8. The electrode of claim 7, wherein the second coating comprises nickel, iron, cobalt, silver, tin, chromium, manganese, palladium, lanthanum, combinations thereof, and alloys thereof.

9. The electrode of claim 1, wherein the first and second nanoparticles are mixed to form a homogenous coating.

10. The electrode of claim 1, wherein the metal particles of the first and second coating are less than 100 nanometers in diameter.

11. An electrolyzer comprising the electrode of claim 1.

12. A fuel cell comprising the electrode of claim 1.

13. A method of preparing a nanoparticle coated electrode comprising:
preparing a first dispersion of nanoparticles in a volatile liquid;
coating a metallic substrate with the dispersion and drying it at low temperature to remove the volatile liquid and form a first coating;
heat treating the coated substrate to fuse the nanoparticles to the substrate at elevated temperature;
preparing a second dispersion of nanoparticles in a volatile liquid;
coating the metallic substrate with the second dispersion and drying it at low temperature to remove the volatile liquid and form a second coating; and
heat treating the coated substrate so as to create a direct metal-to-metal bond between the nanoparticles of the first coating and the nanoparticles of the second coating.

14. The method of claim 13 comprising repeating coating and drying before performing heat treating at elevated temperature.

15. The method of claim 13, wherein the dispersion on the substrate is dried at a temperature of about 300° C. or less.

16. The method of claim 13, wherein the coated substrate is heat treated at a temperature of about 500° C. or more.

17. The method of claim 13 further comprising:
preparing a second dispersion of nanoparticles in a volatile liquid;
coating the coated metallic substrate with the second dispersion to form a second coating, and drying the second coating on the coated metallic substrate at low temperature to remove the solvent; and
heat treating the second coating on the coated substrate to fuse the nanoparticles of the second coating to the coated metallic substrate at elevated temperature.

18. The method of claim 17 comprising repeating coating and drying before performing heat treating at elevated temperature.

19. The method of claim 18, wherein the second dispersion is dried at a temperature of about 300° C. or less.

20. The method of claim 17, wherein the second coating is heat treated at a temperature of about 500° C. or more.
